(19) United States
(12) Patent Application Publication
(10) Pub. No.: US 2024/0226844 A1
(43) Pub. Date: Jul. 11, 2024

(54) PLASMA HEADER FOR COST-EFFECTIVE GAS PROCESSING OF FIXED NITROGEN PRODUCTS

(71) Applicant: NITRICITY INC., Fremont, CA (US)

(72) Inventors: Bradford Oliver, San Francisco, CA (US); Joshua M. Mcenaney, Fremont, CA (US); John A. Schwalbe, Santa Clara, CA (US)

(21) Appl. No.: 18/410,982

(22) Filed: Jan. 11, 2024

Related U.S. Application Data
(60) Provisional application No. 63/438,450, filed on Jan. 11, 2023.

(51) Int. Cl. B01J 19/12; B01J 19/00; B01J 19/24

(52) U.S. Cl. CPC B01J 19/126; B01J 19/0013; B01J 19/2445; B01J 2219/0801; B01J 2219/0871; B01J 2219/0875; B01J 2219/0898; B01J 2219/1218; B01J 2219/1269

(57) ABSTRACT

A system for producing fixed nitrogen products includes a header coupled to one or more plasma torch reactors. The plasma torch reactors receive input gases and generate (e.g., using microwave energy) a plasma and resulting reactive nitrogen species. The reactive nitrogen species oxidize within the header, resulting in a product stream. In certain implementations, the product stream is transported to an absorption unit for conversion into the fixed nitrogen products. Certain implementations include cooling, supplemental fluid, and other systems to vary and enhance production of fixed nitrogen products and operation of the system.

### CROSS-REFERENCE TO RELATED APPLICATION

The present patent application is related to and claims priority under 35 U.S.C. § 119(e) from U.S. Provisional Patent Application No. 63/438,450 titled “Plasma Header for Cost-Effective Gas Processing of Fixed Nitrogen Products” filed on Jan. 11, 2023, the entire contents of what is hereby incorporated by reference for all purposes.

### TECHNICAL FIELD

Embodiments of the present disclosure generally relate to a plasma system for processing or reacting large volumes of gases, and particularly fixing nitrogen and capturing fixed nitrogen products. More specifically, the present invention relates to a system and method for producing plasma-nitrogen fixation where the gaseous fixed nitrogen may be captured to form liquid and solid chemical and fertilizer products, among other things.

### BACKGROUND AND INTRODUCTION

Industrial plasma processing originated with the Birkeland-Eyde process over a century ago. The Birkeland-Eyde process relied on large, inefficient arc reactors, with significant electrode degradation issues and high-cost electricity from fossil fuels. Advancements in materials science, plasma physics, chemical engineering, and power electronics have led to a renewed interest in developing efficient plasma systems. Today, plasma-based processes are poised to take advantage of lower cost renewable electricity, and if they can run efficiently and cost effectively enough, they may be able to replace many fossil-fuel dependent chemical production processes.

In the Birkeland-Eyde process, thermal electrical arcs facilitate reaction of nitrogen with oxygen to create gas-phase oxidized-nitrogen species. Further reacting the gas-phase oxidized-nitrogen species with water can form nitric acid, a source of nitrate for nitrogen-based fertilizers.

However, the thermal plasmas used have limited nitrogen-fixation efficiencies. Thermal arcs are also destructive to electrodes and not optimized for production of oxidized-nitrogen species. Non-thermal plasmas have shown promise to improve energy efficiency of nitrogen fixation over that of thermal arcs. Investigators have explored nitrogen fixation using gliding arcs, dielectric-barrier discharge, corona discharge, radio-frequency plasmas, and others, with microwave plasmas being among the most promising. Under certain conditions, microwave-generators can produce non-thermal plasmas that react nitrogen with oxygen to create gas-phase oxidized-nitrogen species. In these plasma reactors, oxidizing nitrogen can produce corrosive and oxidizing chemicals such as nitric acid, ozone, and nitrous oxides, which need to be considered when handling the products and byproducts. There are also physical and chemical conditions to consider and design for in order to efficiently produce the desirable chemical product and eliminate potential byproducts.

Many architectures of plasma reactors are practically limited in power output or otherwise require systems that are too expensive for commercial implementation. Microwaves generated by magnetrons, for example, are practically limited to about 100-125 kW in commercial systems today, whereas higher powered generation of microwave systems, such as klystrons and gyrotrons, are much more expensive per watt. However, megawatts of power are required to produce significant fertilizer or nitric acid product in a factory. At the same time, capture systems of oxidized nitrogen to produce fertilizer is not significantly limited in unit size, and can be scaled up significantly.

Accordingly, aspects of the present disclosure involve efficiently interconnecting, handling and coordinating the feeds from multiple reactors into a common, which may be a single, backend system for fertilizer production. It is with these observations in mind, among others, that aspects of the present disclosure were conceived.

### SUMMARY

One aspect of the present disclosure is related to a plasma header for use in producing fixed-nitrogen products. In certain implementations, plasma torch reactors (e.g., microwave-based plasma torch reactors) are coupled to and distributed along the length of the plasma header. During operation, the plasma torch reactors receive input gases and sufficient energy to form a plasma that is then ejected into the plasma header. The reactive nitrogen species resulting from the plasma oxidize within the plasma header, forming a product fluid stream, which is transported through the plasma header for subsequent processing. For example, the product fluid stream may be delivered to an absorption unit for capture of one or more fixed nitrogen products.

Another aspect of the present disclosure involves a system including a header defining an internal volume and having an outlet. The system further includes a first plasma torch reactor coupled to the header upstream of the outlet, the first plasma torch reactor configured to receive streams of nitrogen and oxygen gas and to generate reactive nitrogen species within the internal volume, and a second plasma torch reactor coupled to the header upstream of the outlet, the second plasma torch reactor also configured to receive streams of nitrogen and oxygen gas and to generate reactive nitrogen species within the internal volume. The header is configured to permit oxidation of reactive nitrogen species produced by each of the plasma torch reactors within the internal volume to produce a product fluid stream including oxidized nitrogen species.

In some aspects, the plasma torch reactors are microwave plasma torch reactors. A waveguide may be coupled to the respective plasma torch reactors. The system may use a plasma generator for each plasma torch reactor or microwave energy may be distributed from a common generator to more than one plasma torch reactor.

In various possible arrangements, the plasma torch reactors may be coupled with the header or supplemental gas provided into the header to produce a particular flow within the header. For example, the header defines a longitudinal axis and the plasma torch reactor may include a plasma reactor outlet oriented perpendicular to the longitudinal axis. The first (as well as other) plasma torch reactor, which may include outputs into the header, may be operably coupled to the header to form a turbulent flow of input gases within the header. The plasma reactors may also be operably coupled with the header to facilitate formation of a vortex flow within the header. The plasma torch reactors may be operably coupled with the header to produce a flow toward a center of the header and toward the outlet of the header to facilitate formation of a flow approaching smooth laminar flow.

In another aspect, a method may involve receiving reactive nitrogen species within an internal volume of a header, the reactive nitrogen species at least partially produced by a plurality of plasma torch reactors coupled to the header and configured to receive streams of nitrogen and oxygen gas and to generate reactive nitrogen species within the internal volume, producing a product fluid stream including oxidized nitrogen gas species by oxidizing the reactive nitrogen species within the header; and transporting the product fluid stream to an outlet of the header.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not and should not be considered limiting in scope.

FIG. 1 is a diagram of an example system for producing and capturing fixed nitrogen products.

FIG. 2 is a diagram of a system according to this disclosure and including a plasma header coupled to multiple plasma torch reactors.

FIGS. 3-6 illustrate alternative headers having different profiles and different plasma torch reactor distributions.

FIG. 7 illustrates an alternative system including microwave-based plasma torch reactors in which offset waveguides are implemented to address arc detection issues.

FIG. 8 illustrates a plasma header including a supplemental gas system.

FIG. 9 illustrates a plasma header including a jacket-type cooling system.

FIG. 10 illustrates a plasma header including individually cooled plasma torch reactors.

FIG. 11 illustrates a plasma header including an internal cooling tubing bundle.

FIG. 12 illustrates a plasma header including directed plasma torch reactors configured to produce turbulent flow and vortices within the plasma header.

FIGS. 13 and 14 illustrate respective plasma torch reactors configured to produce internal vortices.

FIG. 15 is an illustration of a plasma header in communication with a vertical and gravity-fed absorption unit.

FIG. 16 is an illustration of an example system according to this disclosure including vertically oriented plasma headers.

FIG. 17 is a flow chart illustrating an example method of producing fixed nitrogen products.

### DETAILED DESCRIPTION

Before the present invention is disclosed and described, it is to be understood that this invention is not limited to the particular methods, compositions, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

Concentrations, amounts, and other numerical data may be expressed or presented herein in a range format. It is to be understood that such a range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 2 to about 50” should be interpreted to include not only the explicitly recited values of 2 to 50, but also include all individual values and sub-ranges within the indicated range. Thus, included in this numerical range are individual values such as 2, 2.4, 3, 3.7, 4, 5.5, 10, 10.1, 14, 15, 15.98, 20, 20.13, 23, 25.06, 30, 35.1, 38.0, 40, 44, 44.6, 45, 48, and sub-ranges such as from 1-3, from 2-4, from 5-10, from 5-20, from 5-25, from 5-30, from 5-35, from 5-40, from 5-50, from 2-10, from 2-20, from 2-30, from 2-40, from 2-50, etc. This same principle applies to ranges reciting only one numerical value as a minimum or a maximum. Furthermore, such an interpretation should apply regardless of the breadth of the range or the characteristics being described.

As used herein, the term “about” is used to provide flexibility to a numerical range endpoint by providing that a given value may be “a little above” or “a little below” the endpoint. For example, the endpoint may be within 10%, 8%, 5%, 3%, 2%, or 1% of the listed value. Further, for the sake of convenience and brevity, a numerical range of “about 50 mg/mL to about 80 mg/mL” should also be understood to provide support for the range of “50 mg/mL to 80 mg/ml.” The endpoint may also be based on the variability allowed by an appropriate regulatory body, such as the FDA, USP, etc.

The following disclosure is directed to a system for producing fixed-nitrogen products. The system generally includes plasma sources (e.g., plasma torch reactors) for generating reactive nitrogen species and a plasma header for collecting and transporting the reactive nitrogen species (which may include, but are not limited to ionized nitrogen species, radicals, and reactive but non-charged molecules (e.g., NO)) from two or more plasma sources. While the plasma reaction primarily occurs within respective Plasma Torch Reactors, or PTRs, (e.g., a plasma chamber of the same where input gases are ignited to form a plasma), plasma from the PTRs may also, in some embodiments, be present in the plasma header where reactions may be ongoing. During collection and transport within the plasma header, the reactive nitrogen species are permitted to oxidize into oxidized nitrogen species, forming a product fluid stream. In certain implementations, the product fluid stream is further processed by an absorption unit configured to convert the product fluid stream into one or more fixed nitrogen products.

One of the most efficient and cost-effective ways to make microwaves today is with magnetrons. Magnetrons are presently limited to a few hundred kilowatts (kW) in power, with off-the-shelf commercial units limited to about 100 kW. Increasing the scale of chemical processing equipment is known to decrease the cost per unit of product (so called “economies of scale”). The power limit of magnetrons, however, limits this cost-saving mechanism. For an industrial-scale facility, hundreds of magnetron-based systems may be required, adding to the complexity of a design. In order to efficiently fix nitrogen and capture nitrogen, chemical and physical properties of the reactant reaction, subsequent reactions, and reactive species all need to be taken into account in the design.

This disclosure references various fluid/gas streams at different points in the production of fixed nitrogen products and within different elements of the described systems and system components. For example, each plasma torch reactor may receive one or more input gas streams (e.g., oxygen and nitrogen gases) and produce an output stream including reactive nitrogen species to a plasma header. The reactive nitrogen species may subsequently oxidize within the plasma header, resulting in a product fluid stream at an outlet of the plasma header. While this disclosure generally refers to components of the various streams (e.g., reactive nitrogen species in the output stream from the plasma torch reactors), any reference to such streams recognizes that they may include other components, as well. For example, the output stream from a given plasma torch reactor generally includes reactive nitrogen species when the stream enters the plasma header, but it may also include a proportion of unreacted input gases or reactive nitrogen species that extinguished prior to delivery into the plasma header. Similarly, the product fluid stream from the plasma header generally includes oxidized nitrogen species; however, such oxidized nitrogen species may have been produced from molecules that oxidized within the plasma header, molecules that oxidized prior to delivery into the plasma header (e.g., those that extinguished shortly after production within a given plasma torch reactor), or uncharged molecules (e.g., NO) that oxidized within the plasma header (e.g., into NO₂). The product gas stream may also include other components, including, but not limited to unreacted input gases and supplemental gases (e.g., cooling or oxidation-enhancing gases, each of which are discussed below in further detail). Accordingly, to the extent this disclosure makes reference to a given fluid or gas stream and mentions a component of the stream, this disclosure recognizes that the component may comprise only a fraction of the stream and the stream may include various other components.

This disclosure uses the term “fixed nitrogen products” to refer to the output of the absorption unit. Such products include, without limitation and alone or in combination, HNO₃, HNO₂, Ca₂NO₃, and other nitrate fertilizers. This disclosure anticipates and recognizes that fixed nitrogen products include a broader range of compounds beyond those used in nitrate fertilizers and, as a result, is not limited to applications related to the production of nitrate fertilizers.

This disclosure describes various configurations and implementations of fixed-nitrogen production systems and, in particular, various configurations and implementations of plasma headers for use in such systems and combinations of plasma torch reactors and plasma headers. As illustrated by the various examples included herein, the described system is efficient and flexible, and can be readily scaled or modified to operate in a wide variety of applications.

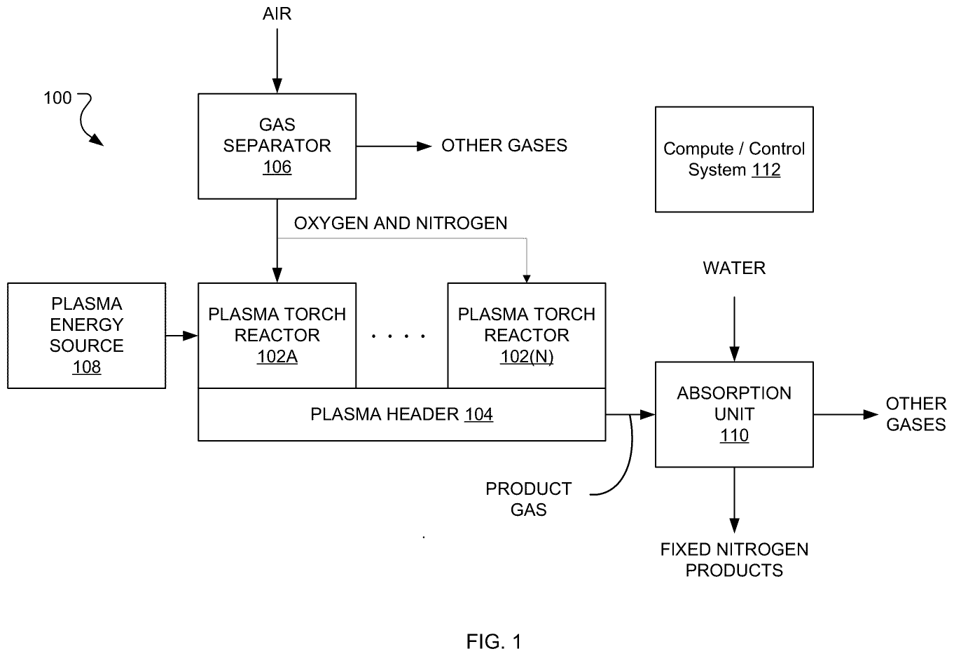

FIG. 1 is a schematic diagram of an example system 100 for producing fixed-nitrogen products, such as those used in the production of fertilizer. In general, system 100 is a plasma-based system in which a plasma torch reactors 102A and 102N (noting the system may have two or more reactors) each generate a plasma from nitrogen and oxygen gas and are fluidically coupled to a plasma header 104, combining the fluidic streams of each reactor, the plasma resulting in a combination of reactive nitrogen and oxygen species. For example, plasma torch reactors 102A and 102N receive nitrogen and oxygen gas from a gas separator 106 capable of isolating or concentrating oxygen and nitrogen gas from air. A common gas separator may provide gas to each of the plasma torch reactors. A plasma energy source 108 provides thermal, electrical, electromagnetic, or other energy to a plasma torch reactor. While only illustrating a plasma energy source connected to a plasma torch reactor 102A, a plasma energy source may be coupled with each plasma torch reactors 102N for generating the reactive species from the nitrogen and oxygen provided by gas separator 106, in which case there will correspondingly be N plasma torch reactors and N plasma energy sources.

The nitrogen-oxygen plasma oxidizes within plasma header 104 to form a product fluid stream including oxidized nitrogen species. An absorption unit 110 in fluid communication with an outlet of plasma header 104 receives the product fluid stream and produces fixed-nitrogen products from the product fluid stream and water. Examples of absorption unit 110 are provided in U.S. patent application Ser. No. 17/240,768, which is incorporated herein by reference. An absorption unit (or units) may be coupled to various embodiments discussed herein to process product fluid streams. The absorption unit 110 may be a packed column, a bubble absorption unit, a spray tower, a plate column, tray column, film column, or a turbulent pool for gas absorption. The absorber may include a diffuser for diffusing the reactor outlet stream into the absorber. For example, the absorber may be a bubble absorption unit and may contain a diffuser for diffusing the reactor outlet stream, e.g., via bubble, into a liquid contained in absorber. In at least one embodiment, the diffuser is submerged in the liquid contained in absorber. The diffuser may be a porous media constructed of ceramic, metal, or glass material.

The absorber may be configured to produce nitrates, nitrites, nitric acid, salts thereof, or a mixture thereof from the reactor outlet stream. In some embodiments, absorber 110 is configured to produce a gas phase and a liquid phase. For example, the absorber may be configured to produce nitrogen compounds (such as, nitrates, nitrites, nitric acid, and/or salts thereof) by dispersing the reactor outlet stream through a liquid phase contained in the absorber. The liquid phase may be water or an aqueous solution. By dispersing the reactor outlet stream throughout the liquid phase (e.g., a liquid phase comprising or consisting of water), certain compounds of the reactor outlet stream are absorbed into the liquid phase and further oxidized to the desired nitrogen compounds. Preferably, about 50 wt. % or more of the oxidized nitrogen species in the reactor outlet stream are converted in the absorbers, based on the total volume oxidized nitrogen species in the reactor outlet stream. For example, the conversion of oxidized nitrogen species in the absorber(s) may be about 30 vol. % to about 90 vol. %; about 40 vol. % to about 90 vol. %, about 50 vol. % to about 90 vol. %, about 60 vol. % to about 90 vol. %, about 70 vol. % to about 90 vol. %, about 80 vol. % to about 90 vol. %; about 30 vol. % to about 80 vol. %; about 40 vol. % to about 80 vol. %, about 50 vol. % to about 80 vol. %, about 60 vol. % to about 80 vol. %, about 70 vol. % to about 80 vol. %; about 30 vol. % to about 70 vol. %; about 40 vol. % to about 70 vol. %, about 50 vol. % to about 70 vol. %, about 60 vol. % to about 70 vol. %; about 30 vol. % to about 60 vol. %; about 40 vol. % to about 60 vol. %, or about 50 vol. % to about 60 vol. %, including any ranges or subranges therebetween, as measured by difference in the total amount/volume of oxidized nitrogen species in the reactor outlet stream and the amount/volume of total oxidized nitrogen species in the gas stream leaving the absorber (e.g., the first absorber). In some cases, any of the foregoing conversions of oxidized nitrogen species is obtained using a plurality of absorbers, as measured by the difference in the total volume/amount of oxidized nitrogen species in the reactor outlet stream and the volume/amount of total oxidized nitrogen species in the gas stream leaving the last absorber (e.g., the most downstream absorber). The compounds traversing through the liquid phase form the gas phase produced by absorber.

The liquid phase of absorber 110 absorbs at least a portion of the nitrates, nitrites, nitric acid, salts thereof, or a mixture thereof. The liquid phase may comprise a basic compound, such as those chosen from calcium carbonate, sodium hydroxide, potassium hydroxide, and a mixture thereof. In certain embodiments, the absorber produces a salt from the nitric compounds by containing a basic compound in the liquid phase. Additionally or alternatively, the liquid phase may comprise an acidic compound including, e.g., nitric acid, phosphoric acid, or sulfuric acid. For example, the liquid phase may contain an acidic compound, such that the liquid phase has a pH of about 0 to about 7, about 2 to about 7, about 3 to about 7, about 4 to about 7, about 4 to about 6.5, about 5 to about 6.5, or any ranges or subranges thereof. In some cases, liquid phase may comprise an oxidizing compounds, such as hydrogen peroxide and/or ozone. For example, the liquid phase may include one or more oxidizing compounds to oxidize one or more nitrogen compounds in the liquid phase. Peroxide can promote the oxidization of nitrites to nitrates. Additionally or alternatively, hydrogen peroxide may promote react with nitrous acid to produce nitric acid and water in the liquid phase. Hydrogen peroxide in water may also increase the ability to capture NO and/or NO₂ by oxidation and accelerating the cascade toward nitrates. Ozone may increase the rate of conversion of NO to NO₂ in the gas phase (NO₂ is more rapidly absorbed by an aqueous liquid phase than NO). For example, ozone may react with NO to produce NO₂ and O₂. In some embodiments, the liquid phase may comprise a catalyst. The catalyst may comprise platinum, palladium, hafnium, molybdenum, tungsten, zirconium, or a mixture thereof. For example, the catalyst may include WO₃, MoO₃, ZrO₂, HfO₂, or combinations thereof.

The system 100 includes a supporting computing system 112 to facilitate control, operation, communication, and data collection from the various components of system 100. For example, the computing system 112 may be configured to collect data from sensors of the various components of system 100 and to issue control signals for operating the components. In certain implementations, the computing system may include a control panel, terminal, or similar computing device for accessing data generated by system 100, modifying operational parameters of system 100, and otherwise using system 100. In certain implementations, the computing system 112 may also transmit data remotely, e.g., to a centralized data store or cloud-based data collection system. The computing system may also facilitate remote access to system 100, including access through an application or other software executed on a remote computing device, such as a smartphone, laptop, desktop, or other computing device. It should be recognized that a computing/control system 112 may be used in various embodiments discussed herein.

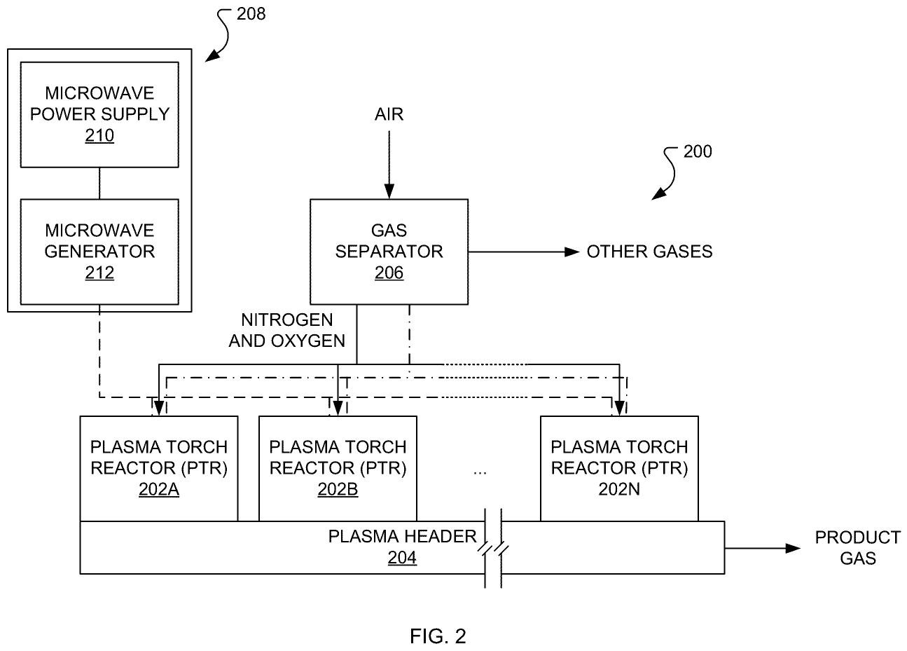

FIG. 2 is an alternative implementation of this disclosure including a system 200 for producing fixed-nitrogen products. System 200 includes a plasma header 204 coupled to multiple plasma torch reactors 202A-N. During operation, plasma torch reactors 202A-N receive nitrogen and oxygen gas from a gas separator 206. Plasma torch reactors 202A-N also receive microwave energy from a microwave system 208 (e.g., through respective waveguides), which includes a microwave power supply 210 and a microwave generator 212.

Each of plasma torch reactors 202A-N receives microwave energy from microwave system 208 and uses the energy to generate a plasma from nitrogen and oxygen gas received from gas separator 206. Plasma header 204 receives the plasma from each of plasma torch reactors 202A-N. As the plasma resides within plasma header 204 and is transported toward an absorption unit (not shown) the plasma oxidizes to form nitrogen species, which the absorption unit converts to fixed-nitrogen products.

In some examples, a PTR will include an independent microwave source for each reactor. In some alternative examples, a microwave source (e.g., a supply and generator) may deliver microwave energy to more than one torch. In such a case, the system may include a waveguide splitter or divider to split the microwave power, e.g., 915 MHz into two or more channels, which then deliver the power to a torch (the plasma chamber in which the source gas is ignited to produce a plasma).

Considering the nitrogen species and fixed-nitrogen products output by system 200, plasma header 204 is preferably formed from a material compatible with nitrogen oxides and/or nitric acid. For example, in certain implementations, plasma header 204 is formed from one or more of stainless steel, Inconel, Hastelloy, titanium, and aluminum.

Systems according to this disclosure are scalable, e.g., to provide different levels and quantities of fixed nitrogen-products. For example, systems according to the present disclosure may include any suitable number of plasma torch reactors and correspondingly sized plasma headers. Similarly, systems may include any suitable number of power systems for providing power to the plasma torch reactors. Stated differently, systems according to this disclosure may include any suitable number of plasma torch reactors and one or more power systems (e.g., microwave power systems), each of which may provide power to one or more of the plasma torch reactors. Similarly, systems according to this disclosure may include one or more gas separators, each of which may provide gaseous inputs to one or more of the plasma torch reactors. for providing the gaseous inputs required by the plasma torch reactors.

While plasma headers of this disclosure are generally illustrated as having a unitary structure, plasma headers may alternatively be built from modular segments. For example, a given plasma header may include multiple sections, each of which may include or be configured to receive and support one or more plasma torch headers. As described below, certain implementations of this disclosure include features for providing additional gases (e.g., oxidizing or cooling gases) or cooling functionality. In such implementations, each modular segment of the plasma header may similarly include the necessary inputs, outputs, conduits, etc. for supporting the additional functionality. Accordingly, this disclosure contemplates that a plasma header may be a modular structure that can be readily expanded or contracted to accommodate different applications, production levels, etc.

Plasma torch reactors may be coupled to plasma headers using any suitable means provided the connection is substantially hermetic and sufficiently resistant to the heat produced by the plasma torch reactors. By way of example, in certain implementations plasma torch reactors can be coupled to plasma headers by flanged connections including heat-resistant gaskets. As another example, plasma torch reactors may be coupled to headers by a heat-resistant epoxy. In additional implementations, plasma torch reactors are coupled with flange or alternative connections able to operate under a wide array of pressure conditions.

In the example of FIG. 2, torch reactors 202A-N are schematically shown as extending along one side of plasma header 204. However, this disclosure contemplates other arrangements of two or more plasma torch reactors (abbreviated in the figures as “PTR”s) integrated with or otherwise operably connected with the plasma header.

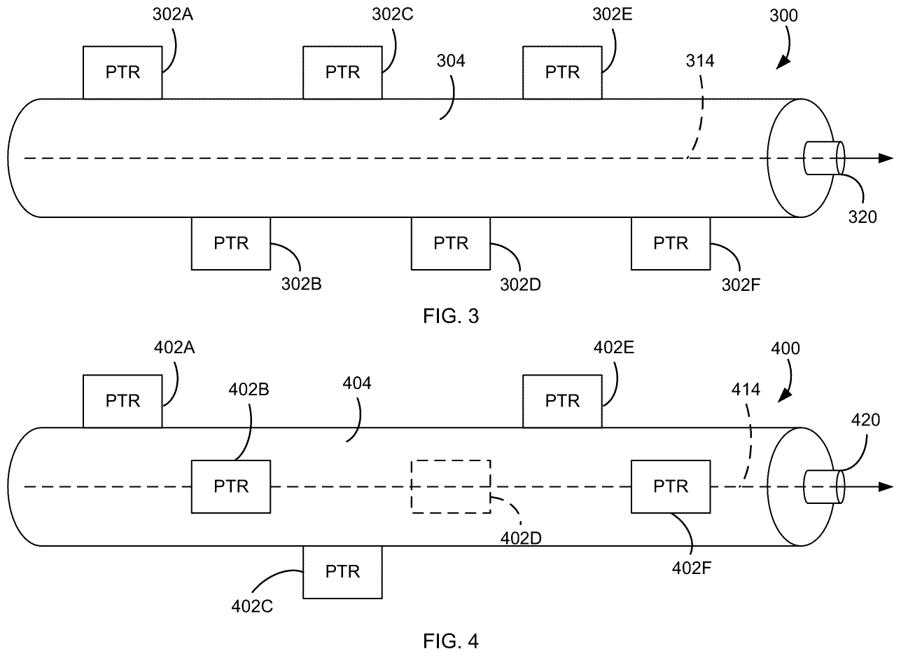

For example, FIG. 3 illustrates a system 300 in which a plasma header 304 has a cylindrical shape. Plasma header 304 defines a cylindrical enclosure that extends along a longitudinal axis 314. As illustrated, system 300 further includes plasma torch reactors 302A-F distributed along the length of plasma header 304. More specifically, plasma torch reactors 302A-F are distributed in an alternating fashion along the length of plasma header 304. So, for example, plasma torch reactors 302A-F alternate between a top and a bottom of plasma header 304 or between opposite sides of plasma torch reactors 302A-F, with about 180 degrees of separation on a radius of the cylindrical enclosure.

FIG. 4 illustrates a system 400 in which a plasma header 404 has a substantially cylindrical shape as well and extends along a longitudinal axis 414. In contrast to system 300, system 400 includes plasma torch reactors 402A-F distributed along the length of plasma header 304 in an orthogonal helical distribution (i.e., longitudinally neighboring plasma torch reactors are offset longitudinally and by 90 degrees along the length of plasma header 404).

In the embodiments of FIG. 3 and FIG. 4, the plasma torch reactors are connected with the plasma header such that the output from plasma torch reactor into the cylindrical enclosure is not directed toward the output of any other plasma torch reactor. This allows each torch to form an independent vortex and prevent sending products into the plasma which may decrease efficiency. In alternatives, a PTR may be aligned with another PTR (pointing at each other or overlapping to some degree), where plasma vortexes may already terminate or each could be used to quench the reactions of the others. Angling the inputs to form a second vortex may also be present in some embodiments, which may have various advantages including using the combined vortexes to protect the walls of the header from overheating. In addition, the ordered vortex flows could be used in combination with the location and directionality of an oxygen input to allow for cool oxygen gas to further quench the reaction and react with the NO to for NO₂ without disrupting the flow. In other embodiments, the PTRs may be oriented toward the center of the header and toward the outlet of the header to smoothly flow together to produce a flow that has more laminar, smooth flowing characteristics. In many embodiments, ports are included on the header or plasma torch reactors (and surrounding systems) for equipping the system with temperature, pressure, viewing, or performance measurement devices.

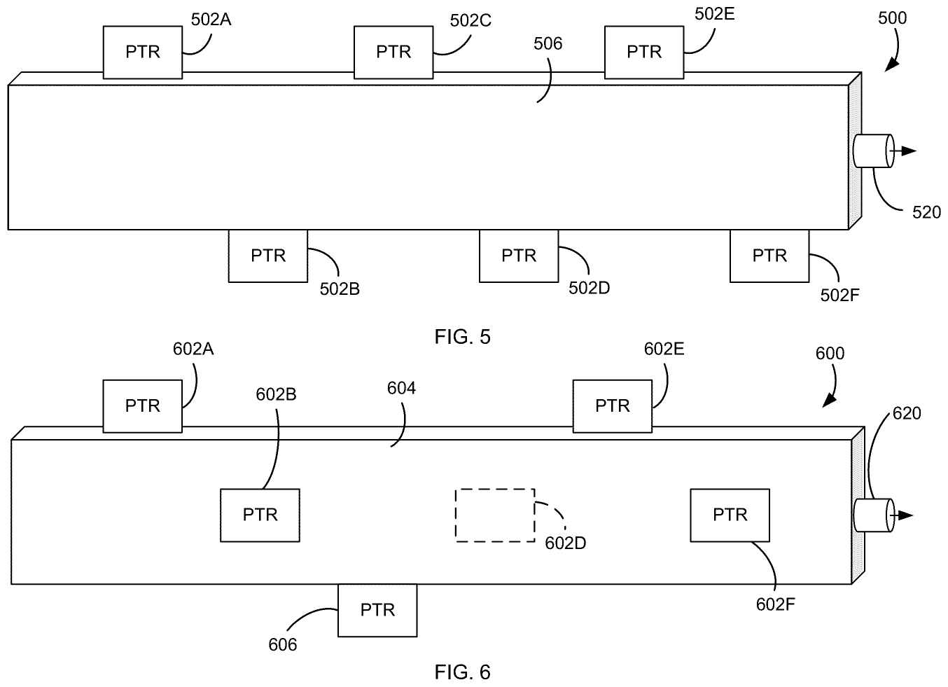

FIGS. 5 and 6 illustrate yet other alternative systems according to this disclosure. Specifically, FIG. 5 illustrates a system 500 similar to system 300 of FIG. 3, albeit with the cylindrical header of system 300 substituted with a rectangular, which may also be square, in cross section header 504. In this example, PTR's are coupled to the header on opposing sidewalls of the header. Similarly, FIG. 6 illustrates a system 600 similar to system 400 of FIG. 4, albeit with the cylindrical header of system 400 substituted with a rectangular header 604 in cross section, which may also be square. Here, PTR's are coupled to each of the four sidewalls of the header. In the embodiments of FIGS. 5 and 6, the plasma torch reactors are coupled with the plasma header such that the output from plasma torch reactor into the rectangular enclosure is not directed toward the output of any other plasma torch reactor.

The output ports 320, 420, 520, 620 in the various embodiments may be centrally located at an output end of the header, which may help facilitate vortex flows within the header. The output port may also allow for near laminar flow if large enough and centrally located at the end. Additionally, any given header may include a valve to control pressure of the header.

More generally, plasma headers in embodiments of this disclosure can have various shapes and sizes. For example, plasma headers may have a generally cylindrical or rectangular box shape, or combinations of the same, with plasma torch reactors distributed longitudinally along the header. In various possible implementations, the header can have any suitable cross-sectional shape or multiple segments with different cross-sectional shapes. Each segment of the plasma header may have a respective perimeter and longitudinally neighboring plasma torch reactors may be disposed at different locations about the perimeter.

While this disclosure generally illustrates and discusses plasma headers having prismatic shapes, other shapes and geometries are contemplated. For example, in addition to prismatic shapes, plasma headers of this disclosure may be spherical, conical, frustoconical, pyramidal, or any other suitable shape for the given application. More generally, plasma headers according to this disclosure provide an oxidization volume for reactive nitrogen species produced by the plasma torch headers. Accordingly, plasma headers of this disclosure may have any suitable shape and size and the overall size and shape of a plasma header may be varied based on required output volume, space restrictions, and other similar parameters.

The number and distribution of plasma torch reactors in implementations of this disclosure may also vary. As noted above, in plasma headers with prismatic shapes, plasma torch reactors may be distributed longitudinally along the plasma header. In certain implementations, spacing/arrangement of plasma torch reactors may be selected to reduce or eliminate potential interference between plasma torch reactors. For example, plasma torch reactors may be spaced and/or arranged to prevent interaction between microwave energy that may enter the plasma header from nearby plasma torch reactors. As another example, plasma torch reactors may be spaced and/or arranged to prevent interaction between output gas flows from nearby plasma torch headers.

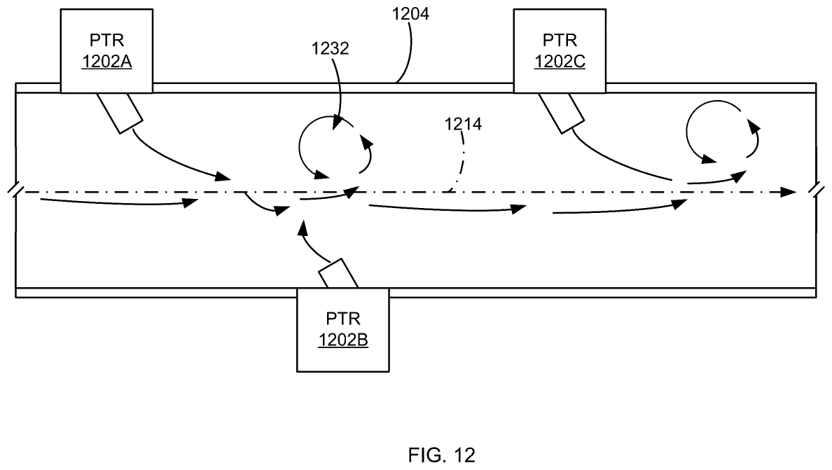

In alternative implementations, plasma torch reactors may be spaced and/or arranged to encourage interaction between nearby plasma torch reactors. As discussed below in the context of FIG. 12, for example, plasma torch reactors may be arranged to promote interaction between the output streams from nearby plasma torch reactors for purposes of generating vortices and otherwise inducing various flow patterns within the plasma header.

The foregoing concepts regarding plasma torch reactor spacing and arrangement apply regardless of the size and shape of the plasma header. For example, in implementations in which the plasma header is cylindrical, such as in FIGS. 3 and 4, plasma torch reactors may be arranged about the cylindrical header to reduce interference and/or control interactions between plasma torch reactors and/or the fluid streams into the plasma header. A plasma header may also be spherical with two or more PTRs connected with the spherical body. An outlet may be provided on the bottom or sides of the sphere, in various examples.

Plasma headers may also include internal structures of various shapes and configurations. For example, a plasma header having an overall cylindrical shape with domed heads may include an internal conical structure or other internal structures (e.g., baffles, vortex breakers, vanes, etc.). In certain implementations, such internal structures may be used to control interaction between plasma torch headers, e.g., by guiding microwave energy and/or output flows from the plasma torch headers.

Plasma headers according to this disclosure may also be equipped with any suitable sensors, safety elements (e.g., safety valves), and control elements to facilitate monitoring and operation of the plasma torch reactors, plasma header and associated equipment.

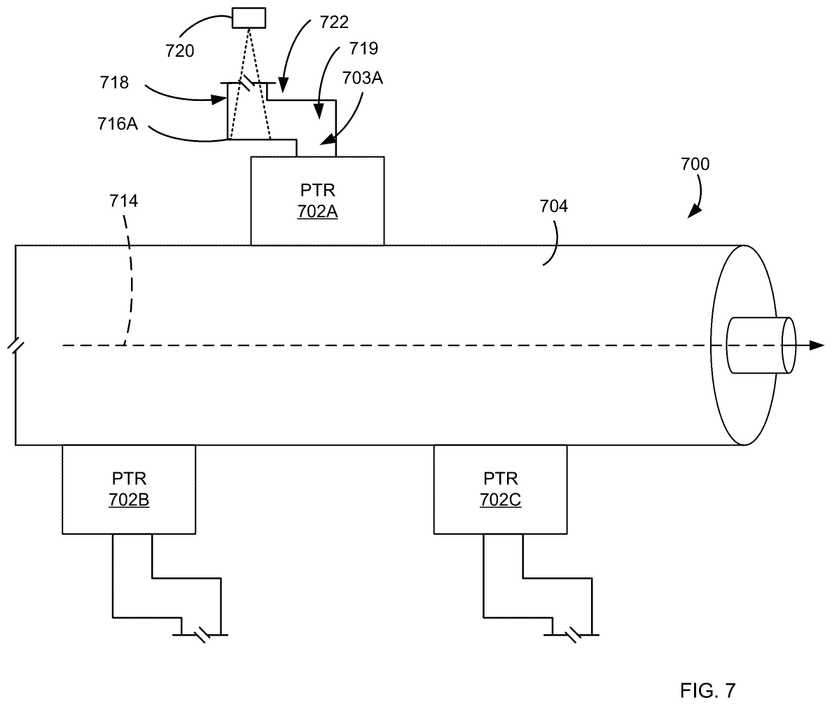

Also, while FIG. 7 illustrates a system 700 including a plasma header 704 defining a longitudinal axis 714 and plasma torch reactors 702A-C coupled to plasma header 704, and configured to generate a plasma within plasma header 704 from oxygen and nitrogen gas, which as discussed above may be sourced in whole or in part from air. As previously discussed, in certain implementations, plasma torch reactors 702A-C are microwave plasma torch reactors and, as a result, are coupled to and receive microwave power from one or more microwave power systems. In general, a microwave power system includes a microwave generator (e.g., a magnetron) that produces electromagnetic waves. The electromagnetic waves are delivered to each of plasma torch reactors 702A-C by waveguides. For example, plasma torch reactor 702A is shown as being coupled to a waveguide 716A.

The size and geometry of waveguides are generally designed based on the characteristics of the microwave energy being delivered. For example, the cross-sectional dimensions, bend angles, material, etc. of a waveguide are commonly selected based on the wavelength and frequency of the microwave energy delivered.

Microwave power systems include a variety of systems to ensure safe operation. Among other things, many microwave power systems include arc detection functionality. Generally, a controller or computer system monitors the internal volume of a portion of the microwave system (e.g., the internal volume of a waveguide) using one or more optical sensors. In response to the optical sensor detecting a flash or burst of light indicative of arcing within the system, the controller may shut the microwave power system down or otherwise alter its operation into a safer state.

Plasmas generate substantial amounts of light when formed. As a result, when plasma is generated using a microwave-based power source, the light produced by the plasma may be sufficient to trigger an arc detection system and subsequent shutdown of the microwave power system or transition of the microwave generation system into a low power state.

Waveguides of system 700 are configured to reduce potential false arc detections. For example, plasma torch reactor 702A generally includes a microwave inlet 703A coupled to waveguide 716. Waveguide 716 includes a first segment 718 (i.e., an upstream segment) observable by an optical sensor 720 of the microwave power system (e.g., microwave power system 208 described with regard to FIG. 2) for purposes of arc detection within the microwave system. Waveguide 716A also includes a second segment 719 (i.e., a downstream segment) in communication with first segment 718 and microwave inlet 703A. Notably, first segment 718 is offset from microwave inlet 703A, thereby reducing the likelihood that light produced by plasma generated within plasma torch reactor 702A will be detected by optical sensor 720 and trigger detection of an arc. In one example, the first segment is offset from the second segment by way of a transverse segment 722. The waveguide, and each segment, defines a square or rectangular cross section through which the microwaves are directed to the respective PTR.

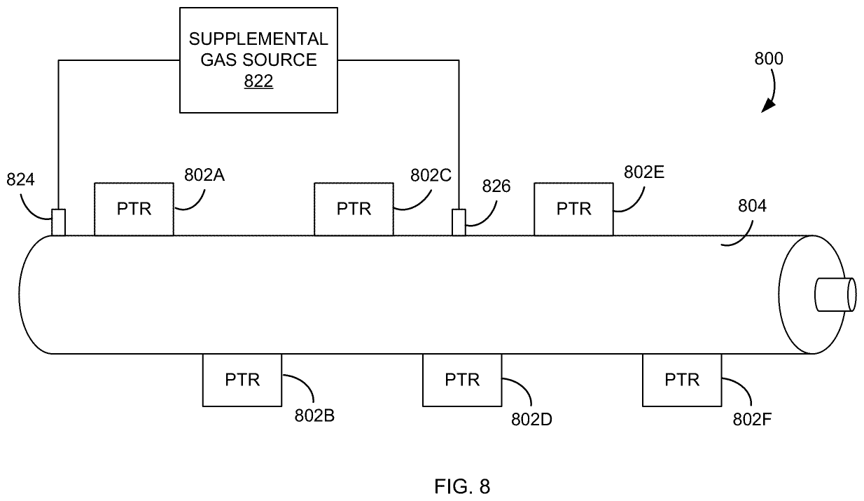

In certain implementations, plasma headers according to this disclosure may be coupled to supplemental gas sources. For example, FIG. 8 is a schematic illustration of a system 800 including a plasma header 804 coupled to plasma torch reactors 802A-F. System 800 further includes a gas source 822 coupled to plasma header 804 to provide supplemental gas to the internal volume of plasma header 804. In the specific example of FIG. 8, gas source 822 provides supplemental gas into plasma header 804 through a first inlet 824 located at an upstream location of plasma header 804 and a second inlet 826 positioned at a central location along plasma header 804 (i.e., between plasma torch reactors).

The supplemental gas provided by gas source 822 can serve one or more purposes. For example, in certain implementations, the supplemental gas may be an inert gas and may be provided for purposes of increasing flow of the product gas through plasma header 804. Examples of inert gases include Argon and Nitrogen, each of which may be introduced in the plasma header after the PTRs. As another example, the supplemental gas may include oxygen or another oxidizing component to promote oxidation of nitrogen species within plasma header 804. The supplemental gas may also be nitrogen or air. In yet another implementation, the supplemental gas may be provided for purposes of cooling the plasma header 804. In such a case, the supplemental gas may quench any continuing plasma reactions and help reduce any back reactions. When quenching, the supplemental gas may provide molecular surfaces for the hot gases and species to dump their energy to rapidly cool the same. The supplemental gas may be provided at “room” temperature.

In at least certain implementations, supplemental gas may be provided at various locations along plasma header 804. An oxidizing gas, for example, may be injected into the plasma header 804 at multiple locations to ensure that the concentration of oxidizing gas remains relatively high along the length of plasma header 804, promoting more complete oxidation of reactive nitrogen species produced by the plasma torch reactors. As another example, cooling gas may be injected at multiple locations along plasma header 804 to ensure adequate cooling within plasma header 804. In some implementations, these gas inputs may be oriented at an angle with spacing designed to direct gas flow in cyclical or turbulent paths throughout the header interior to assist with heat transfer or gas progression through the system.

While supplemental gas may be used to cool systems according to this disclosure, this disclosure further contemplates other possible cooling systems.

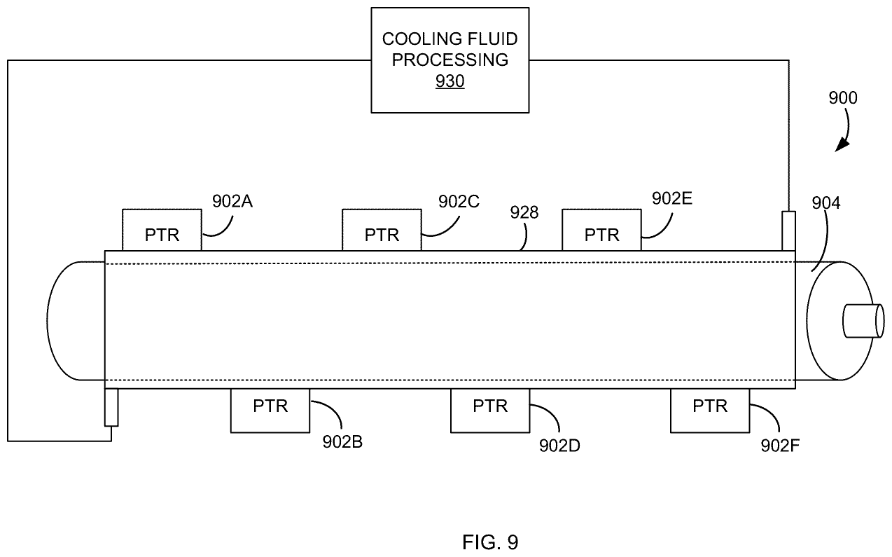

FIG. 9, for example, illustrates a system 900 in which a plasma header 904 is cooled by a jacket-based system. More specifically, system 900 includes a cooling jacket 928 disposed around 904 and connected to a cooling fluid processing system 930, which may include pumps or other fluid circulation devices and heat exchangers or similar cooling devices. During operation, cooling fluid system 930 circulates a cooling fluid through cooling jacket 928 to cool an external surface of plasma header 904. The jacket may involve some form of channels, tubes or coils in thermal contact with the surface of the plasma header, carrying coolant to transfer heat. The jacket may further include a heat exchanger to cool the heated coolant. The plasma header may further include some form of air cooling, alone or in combination with the fluid-based system, which may include a fan or fans to transfer air across veins in thermal contact with the coolant fluid carrying structure and/or the plasma header.

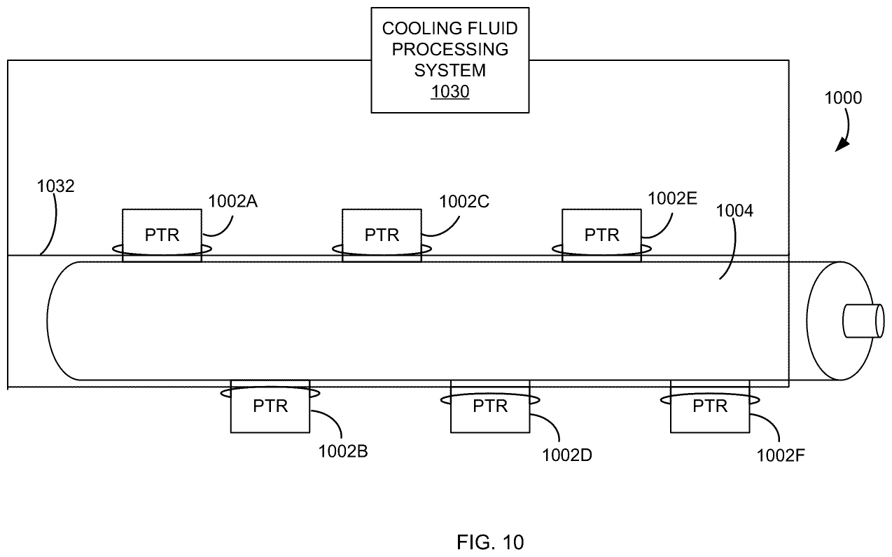

FIG. 10 illustrates another system 1000 that relies on direct cooling of the plasma torch reactors. More specifically, system 1000 includes a plasma header 1004 with plasma torch reactors 1002A-F. System 1000 further includes a cooling fluid processing system 1030, which, like the previous example, includes equipment for transporting and cooling fluid. In contrast to the previous example, cooling fluid processing system 1030 includes conduit 1032 that is routed/coiled around each plasma torch reactor 1002A-F to directly cool the plasma torch reactors.

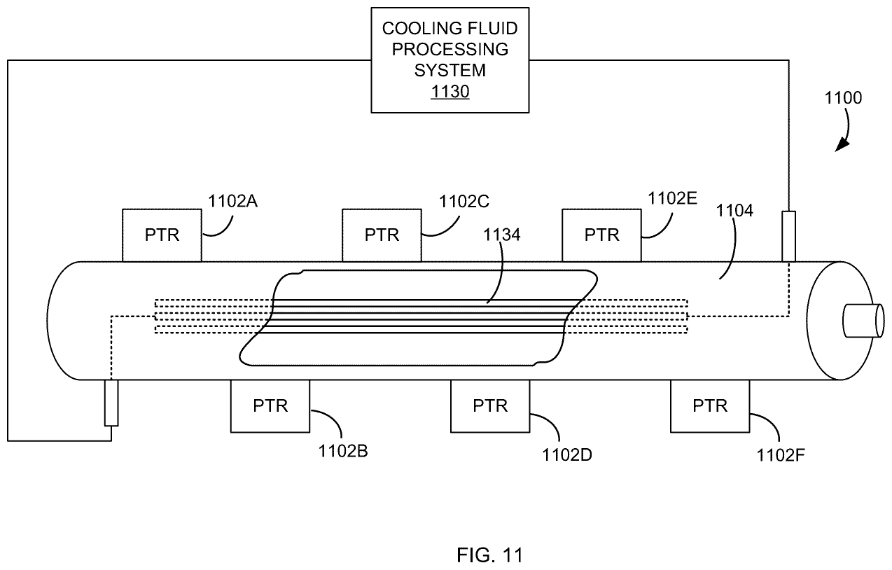

FIG. 11 illustrates yet another system 1100 including cooling functionality. System 1100 includes a plasma header 1104 with plasma torch reactors 1102A-F. In contrast to the external cooling systems of the previous examples, system 1100 includes an internal cooling system in which fluid provided by a cooling fluid processing system 1130 is passed through conduit, tubing, or a tubing bundle (e.g., tubing bundle 1134) extending along the internal volume of plasma header 1104. In one example, coiled cooling conduits are wrapped around the hot plasma zone of each reactor torch (the plasma chamber in which the plasma is ignited) to keep the temperature within the operating range of the reactor torch chamber materials.

The foregoing examples of cooling systems are non-limiting and are not mutually exclusive. For example, certain implementations may include the internal cooling of system 1100 with the jacket-type cooling of system 900 or the direct reactor cooling of system 1000. Moreover, while illustrated in FIGS. 9-11 as being an independent cooling system, plasma header cooling elements may instead be tied into a broader cooling system, e.g., cooling systems that also provide cooling to power systems and other processing vessels.

While not illustrated, cooling systems according to this disclosure may also include or be coupled to one or more waste heat recovery systems for recovering heat from fluid of the cooling system and using the recovered heat for other uses. By way of non-limiting example, such uses may include providing heating for HVAC or other building climate systems or for providing heating for other chemical or industrial processes.

Plasma torch reactors may be arranged or otherwise configured to produce turbulent flow within plasma headers to which they are coupled. In certain implementations, such turbulent flow may include the formation of vortices within the internal volume of the plasma header.

FIG. 12 illustrates one example in which plasma torch headers are oriented to produce directed and turbulent flow within a plasma header. Specifically, FIG. 12 illustrates a plasma header 1204 defining a longitudinal axis 1214 with three plasma torch reactors 1202A-C coupled to the plasma header 1204. In general, plasma torch reactors produce an output stream including ions of the input gases. The output stream from a given plasma torch reactor may also include unreacted input gases, extinguished ions, and other reactive and non-reactive molecules (e.g., reactive nitrogen species). Accordingly, by changing the angle of plasma torch reactors 1202A-C relative to longitudinal axis 1214, the output stream produced by plasma torch reactors 1202A-C and the resulting product gas as the reactive molecules of the output stream oxidize can be modified. In another example, the torches may be arranged to generate a vortex flow within a cylindrical chamber. Here, PTR 1202 would be oriented like PTRs 1202A and 1202B, with each PTR also oriented tangentially relative to a longitudinal centerline of the cylindrical plasma header or otherwise oriented to collectively generate a vortex flow around the cylindrical sidewalls of the chamber and about the longitudinal centerline within the header.

Considering the foregoing, in at least certain implementations, plasma torch reactors in systems according to this disclosure may be oriented substantially perpendicular to a longitudinal axis of the plasma header. Alternatively, plasma torch reactors may be oriented non-perpendicularly relative to the longitudinal axis of the plasma header. For example, and as illustrated by each of plasma torch reactors 1202A and 1202C, plasma torch reactors may be angled relative to longitudinal axis 1214 such that the outlet of the plasma torch reactors is directed in a downstream direction. Plasma torch reactor 1202B is also illustrated as being angled relative to longitudinal axis 1214, albeit in an upstream direction. As shown in FIG. 12, the interaction of the outputs of the various plasma torch reactors results in turbulent flow within plasma header 1204 and the formation of vortices, such as vortex 1232.

While the plasma torch reactors illustrated in FIG. 12 are shown as having outlets and producing plasma streams that are substantially coplanar with longitudinal axis 1214, in at least certain implementations, plasma torch reactors may be oriented to have outlets that are skewed (i.e., non-intersecting and non-parallel) with respect to longitudinal axis 1214.

In addition to orienting the plasma torch reactor outlets to produce turbulent flow and possible vortices within the plasma header, the plasma torch reactors may also be configured to produce internal gas vortices. In addition to promoting development of vortices within the plasma header, forming vortices within the plasma torch reactors can also help to direct plasma into the plasma header and away from the walls of the plasma torch reactors.

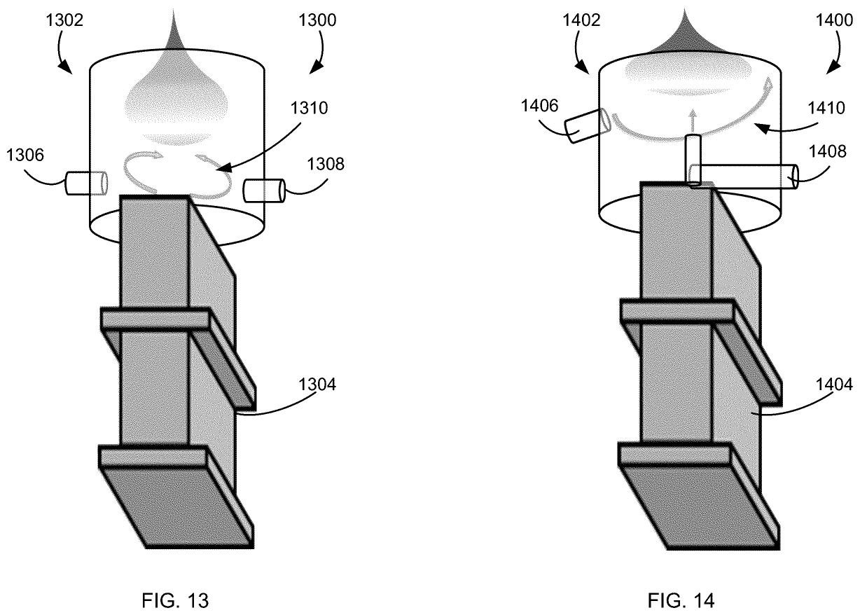

Two examples of such designs are provided in FIGS. 13 and 14. Referring first to FIG. 13, a plasma torch reactor 1300 includes a reactor chamber 1302 coupled to a waveguide 1304 through which microwave energy is delivered into reactor chamber 1302. Two gas inlets (gas inlet 1306 and gas inlet 1308) provide gas to reactor chamber 1302 and are subsequently formed into a plasma by the microwave energy. As previously discussed, in most applications, the gasses provided to the plasma torch reactor 1300 include nitrogen and oxygen and may be optionally provided by a gas separator upstream of plasma torch reactor 1300. Gas inlet 1306 and gas inlet 1308 are positioned opposite each other such that the gas streams from the inlets interact to form a vortex 1310.

Referring next to FIG. 14, a plasma torch reactor 1400 includes a reactor chamber 1402 coupled to a waveguide 1404 through which microwave energy is delivered into reactor chamber 1402. Two gas inlets (gas inlet 1406 and gas inlet 1408) provide gas to reactor chamber 1402 and are subsequently formed into a plasma by the microwave energy. In contrast to the previous example in which the gas inlets were illustrated as being opposed across reactor chamber 1302, FIG. 14 illustrates gas inlet 1408 extending into reactor chamber 1402 and coaxial with reactor chamber 1402 with gas inlet 1406 providing an angled gas flow into reactor chamber 1402, again resulting in the production of a vortex 1410 within reactor chamber 1402.

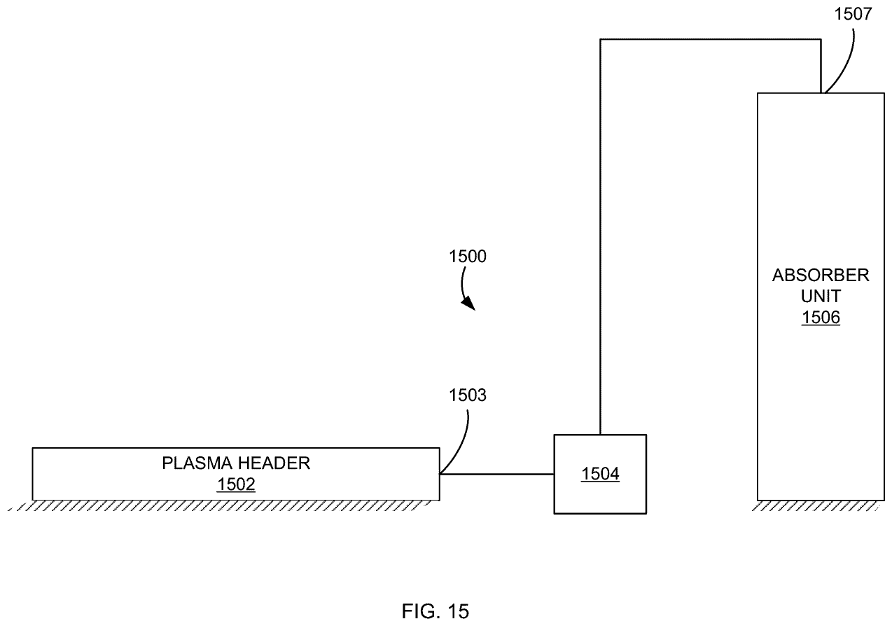

FIG. 15 illustrates a schematic diagram of a system 1500 for producing fixed nitrogen products. For simplicity, system 1500 includes each of a plasma header 1502, a fluid transfer device 1504, and an absorption unit 1506. Other aspects of systems according to the present disclosure (such as plasma torch reactors, gas separators, cooling systems, etc.) and inputs are omitted for simplicity.

As shown in FIG. 15, plasma header 1502 is generally coupled to absorption unit 1506 such that product gas produced within plasma header 1502 can be readily transported to absorption unit 1506 for further processing, namely, for formation into fixed nitrogen products. While absorption unit 1506 and plasma header 1502 are not limited to any particular orientation. In the specific implementation illustrated in FIG. 15, however, absorption unit 1506 is configured to be gravity fed and, as a result, is shown in a substantially vertical orientation with an inlet 1507 disposed on top of absorption unit 1506. To facilitate transfer of fluid (e.g., product gas) from plasma header 1502 to absorption unit 1506, fluid transfer device 1504 is positioned between plasma header 1502 and absorption unit 1506 or otherwise promotes fluid transport between an outlet 1503 of plasma header 1502 and inlet 1507 of absorption unit 1506. For example, fluid transfer device 1504 may be a pump, blower, compressor, or similar device.

As previously discussed, plasma headers according to this disclosure may be provided with supplemental gas. In at least certain implementations, the supplemental gas may be pressurized or otherwise provided in a manner sufficient to deliver product gas from plasma header 1502 to absorption unit 1506 for gravity feeding. In other implementations, plasma header 1502 may be positioned above inlet 1507 such that product gas from plasma header 1502 flows into inlet 1507, possibly obviating the need for fluid transfer device 1504. The supplemental gas may be provided through a valve (or valves) or other structure to alter or control the pressure within the header. In general, a lower pressure may be beneficial for plasma ignition within the interconnected PTRs and higher pressure may be conducive to processing efficiency within the header and/or PTRs. While supplemental gas is the focus, it is also possible to inject liquids (e.g., water) at the supplemental inputs in the plasma header and/or inject solids into the plasma header.

Absorption unit 1506 may require that the product gas stream received from plasma header 1502 have a particular pressure, temperature, or other characteristics. In certain implementations, plasma header 1502 may be configured to provide the product gas stream with the corresponding characteristics at outlet 1503. For example, as previously discussed (e.g., in the context of FIG. 8-11, plasma header 1502 may include various systems for cooling components of plasma header 1502 and/or fluid streams within plasma header 1502. Plasma header 1502 may also include or be coupled to components for controlling pressure within plasma header 1502. For example, and without limitation, plasma header 1502 may be coupled to a source of supplemental pressurized gas (e.g., similar to the implementation illustrated in FIG. 8) and a corresponding system for controlled delivery of the gas into plasma header 1502 to maintain the internal volume of plasma header 1502 above a certain pressure threshold or within a certain pressure range. Similarly, plasma header 1502 may include a relief valve or similar device/system for reducing pressure within plasma header 1502.

Properties of the products produced by plasma header 1502 may also be modified by equipment disposed between plasma header 1502 and absorption unit 1506. For example, fluid transfer device 1504 may be configured to pressurize products of plasma header 1502. In other implementations, a pressure vessel or similar pressure control system may be disposed between plasma header 1502 and absorption unit 1506 to modify pressure of products produced by plasma header 1502 prior to delivery to absorption unit 1506. Temperature may similarly be altered by equipment (e.g., heaters, coolers, heat exchangers, etc.) positioned between plasma header 1502 and absorption unit 1506.

System 1500 of FIG. 15 illustrates an example implementation in which product gas from a single plasma header is fed to a single absorption unit. In general, the number of plasma headers, absorption units, and other ancillary systems (e.g., gas separators, cooling systems, microwave systems, etc.) can vary between applications. For example, in certain cases, the absorption unit may have sufficient capacity to receive and process product gas produced in multiple, parallel plasma headers. As another example, product gas from one or more plasma headers may be provided to multiple absorption units to facilitate distribution of the resulting fixed nitrogen products. Similarly, a single cooling system may be sufficiently sized to provide cooling functionality for multiple plasma headers and absorption units. Alternatively, cooling of systems according to the present disclosure may be distributed across multiple, independently controllable cooling systems, each of which may be configured to provide cooling according to respective parameters. As a final example, multiple plasma headers may be fed from a single gas separator or a single plasma header may be fed from multiple gas separators.

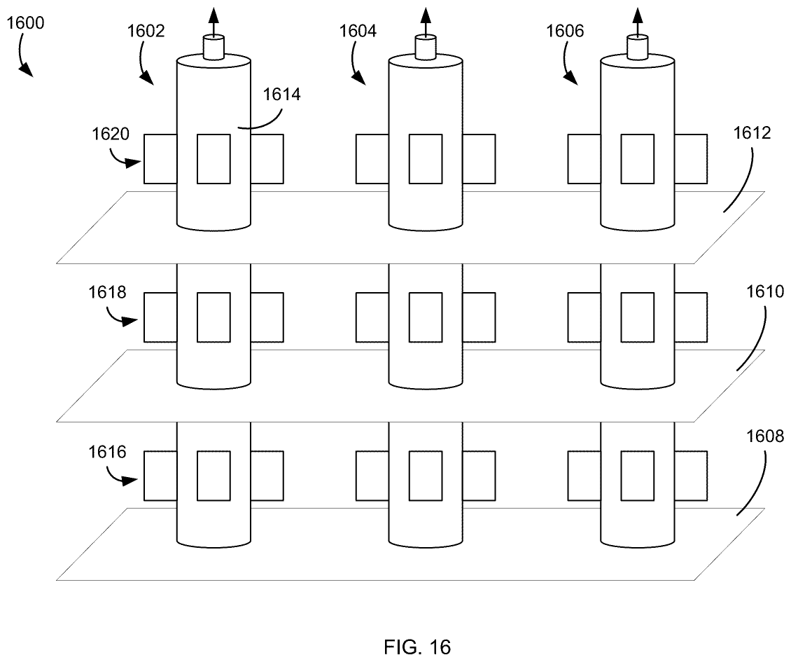

FIG. 16 is an illustration of a system 1600, which is another example embodiment of the present disclosure. System 1600 includes plasma subsystem 1602, plasma subsystem 1604, and plasma subsystem 1606. In system 1600, each of plasma subsystem 1602, plasma subsystem 1604, and plasma subsystem 1606 are substantially similar. For clarity and conciseness, the following discussion will focus on plasma subsystem 1602 and its components. Unless otherwise specific, the description of plasma subsystem 1602 generally applies to plasma subsystem 1604 and plasma subsystem 1606, as well.

System 1600 is intended to illustrate an implementation of this disclosure in which one or more plasma subsystems is vertically oriented. Plasma subsystem 1602, for example, includes a vertically oriented plasma header 1614 and multiple plasma torch reactors distributed along the length of vertically oriented plasma header 1614. In the specific embodiment illustrated in FIG. 16, the plasma torch reactors are arranged in a first set 1616, a second set 1618, and a third set 1620, each of which includes multiple plasma torch reactors distributed about the circumference of vertically oriented plasma header 1614.

FIG. 16 is a simplified illustration of system 1600 and omits various ancillary components and subsystems of system 1600. For example, system 1600 may include one or more power systems (e.g., microwave system 208 of system 200 shown in FIG. 2) for providing power to the plasma torch reactors, one or more gas separators for providing input gas to the plasma torch reactors, one or more cooling systems, one or more supplemental fluid systems, and various downstream systems for processing the products that exit the plasma subsystems.

As shown, plasma subsystem 1602 is generally configured to be segmented into different levels or stories and for each of the plasma torch reactors sets to be accessible or otherwise corresponding to a respective level. For example, first set 1616 corresponds to a first floor 1608, second set 1618 corresponds to a second floor 1610, and third set 1620 corresponds to a third floor 1612.

The specific arrangement of floors and plasma torch reactors of plasma subsystem 1602 shown in FIG. 16 is intended as a non-limiting example. Other implementations of this disclosure may include more or fewer subdivisions/floors. Plasma subsystems of this disclosure may also be configured with different arrangements of plasma torch reactors such that multiple sets of plasma torch reactors can be accessible from a single floor. As previously noted, the plasma torch reactors shown in FIG. 16 are arranged in sets in which each plasma torch reactor is at approximately the same longitudinal location along plasma header 1614. As discussed above (e.g., in the context of FIGS. 3 and 4), other arrangements of plasma torch reactors are also within the scope of this disclosure (e.g., plasma torch reactors alternating on opposite sides of plasma header 1614 or orthogonally offset along plasma header 1614).

While system 1600 illustrates each floor corresponding to a group of plasma torch reactors, additional floors may be included that do not include plasma torch reactors. For example, additional floors may be included for accessing supplemental fluid inlet/outlets, cooling inlet/outlets, power system components, or for otherwise facilitating access and maintenance of plasma subsystem 1602.

The floors illustrated in FIG. 16 is also a non-limiting example of structural elements that may be used to support plasma subsystems when vertically oriented. For example, instead of or in addition to flooring, a stair tower adjacent the plasma header or a staircase that extends around the plasma header may be included. In such implementations, the staircases may include optional and strategically located landings to facilitate access and servicing of the plasma subsystem.

In system 1600, each of the plasma subsystems is substantially similar. While certain implementations of this disclosure may include multiple, substantially similar plasma subsystems, one or more plasma subsystems in other implementations may vary. For example, certain systems may include both vertically and horizontally oriented plasma headers. As another example, the plasma torch reactors of one plasma subsystem may be configured differently (e.g., may have a different layout or performance characteristics) than those of another plasma subsystem. In still other examples, the plasma header of one plasma subsystem may differ in geometry, cooling system configuration, arrangement of supplemental fluid inlets/outlets, or any other aspect of the plasma header. Moreover, while system 1600 includes three plasma subsystems, other implementations of this disclosure may include one or more plasma subsystems and any suitable arrangements of cooling systems, supplemental gas systems, gas separators, absorption units, power systems, etc., as previously discussed.

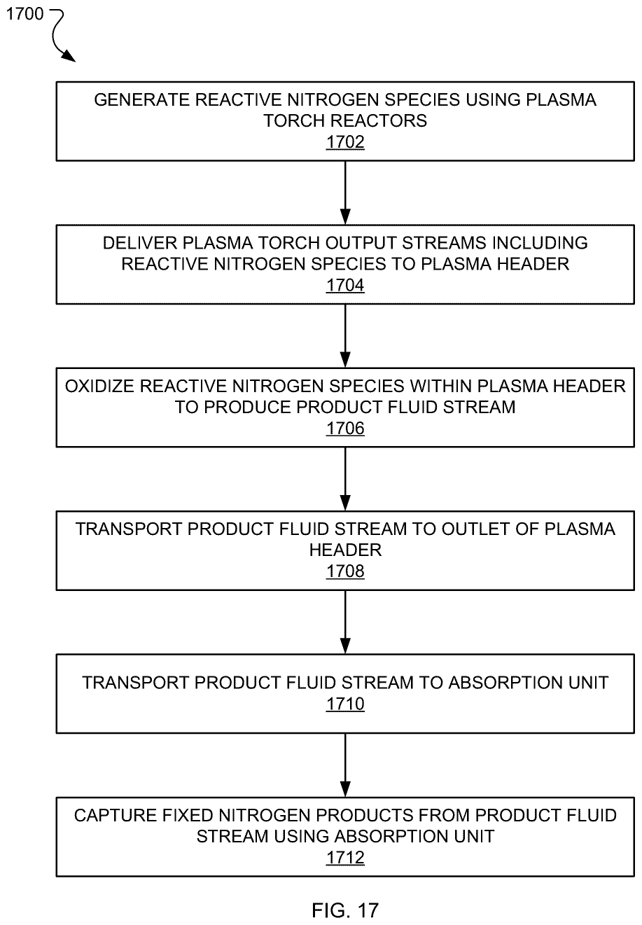

FIG. 17 is a flowchart illustrating a method 1700 for producing fixed-nitrogen products. By way of non-limiting example, method 1700 is described below in the context of system 200 (shown in FIG. 2), and with reference to components of system 200.

Nevertheless, the following method may be readily adapted for execution by any of the systems (and their variations) described in this disclosure and otherwise encompassed by this disclosure.

At step 1702, one or more of plasma torch reactors 202A-N generate reactive nitrogen species. In the context of system 200, for example, each of plasma torch reactors 202A-N receives nitrogen and oxygen gas from a gas separator 206. Plasma torch reactors 202A-N further receive microwave energy from microwave system 208 to generate a plasma from the received gas and that includes or results in reactive nitrogen species. In other implementations, plasma torch reactors 202A-N may rely on an alternative energy source, such as thermal or electrical energy, to generate the plasma are resulting reactive nitrogen species.

At step 1704, output streams for one or more of the plasma torch reactors 202A-N are delivered to an internal volume of plasma header 204, e.g., as a result of plasma torch reactors 202A-N being in fluid communication with plasma header 204. At least some of the output streams received by plasma header 204 include reactive nitrogen species generated during step 1702. However, a given output stream for a plasma torch reactor may include other components. For example, certain reactive nitrogen species generated by a plasma torch reactor may be quenched shortly after generation and prior to delivery into plasma header 204. At least some of the feed gases (e.g., oxygen and nitrogen) provided to but not converted into a plasma by the plasma torch reactor may also be part of the output stream. Accordingly, the output stream for a given plasma torch reactor may include a combination of one or more of reactive nitrogen species, quenched nitrogen species ions, and feed gases. Nevertheless, the following description of method 1700 assumes that the collective output streams of the one or more plasma torch reactors 202A-N noted above in step 1702 and that are delivered into plasma header 204 include at least some reactive nitrogen species.

At step 1706, the reactive nitrogen species delivered into plasma header 204 in step 1704 oxidize within plasma header 204, resulting in a product fluid stream including oxidized nitrogen gas species. The oxidized gas species included in the product fluid stream may be the result of one or more oxidation processes. Stated differently, some of the oxidized gas species may be the result of oxidation of the reactive nitrogen gas species; however, the oxidized gas species may also include products of multiple oxidation reactions. So, for example, oxidation of the reactive nitrogen gas species may produce an intermediate product that is further oxidized to form the oxidized nitrogen gas species of the product fluid stream (or another intermediate product that may be further oxidized). This disclosure also recognizes that other components of the output streams received from plasma torch reactors 202A-N may also undergo oxidation within plasma header 204 and may result in the production of oxidized nitrogen gas species included in the product fluid stream.

At step 1708, the product fluid stream is transported to an outlet of plasma header 204. At step 1710, an absorption unit receives the product fluid stream and, at step 1712, captures fixed nitrogen products from the product fluid stream.

In at least certain implementations, method 1700 may further include introducing a supplemental fluid stream into the internal volume of plasma header 204. For example, the supplemental fluid stream may include one or more of an oxidizing gas for enhancing oxidation of the reactive nitrogen species within plasma header 204; a cooling fluid to promote cooling of the reactive nitrogen species, oxidized nitrogen species, plasma header 204 or other components or products (whether final or intermediate) of system 200 during operation; or an inert gas intended to improve flow through plasma header 204.

In other implementations, method 1700 may further include cooling plasma header 204 or components thereof (e.g., plasma torch reactors 202A-F) either externally or internally, as illustrated in and discussed in the context of FIGS. 9-11. Relatedly, method 1700 may also include extracting heat from a cooling system using a waste heat recovery system and optionally using the extracted heat for another heating application.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment”, or similarly “in one example, “in one instance”, or “in one aspect” or the like in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

What is claimed:

1. A system comprising:
a header defining an internal volume and having an outlet; and
a first plasma torch reactor coupled to the header upstream of the outlet, the first plasma torch reactor configured to receive streams of nitrogen and oxygen gas and to generate reactive nitrogen species within the internal volume;
a second plasma torch reactor coupled to the header upstream of the outlet, the second plasma torch reactor also configured to receive streams of nitrogen and oxygen gas and to generate reactive nitrogen species within the internal volume; and
wherein the header is configured to permit oxidation of reactive nitrogen species produced by each of the plasma torch reactors within the internal volume to produce a product fluid stream including oxidized nitrogen species.

2. The system of claim 1, wherein the first plasma torch reactor is a first microwave plasma torch reactor and the second plasma torch reactor is a second microwave plasma torch reactor.

3. The system of claim 2 further comprising a first waveguide coupled to and in communication with the first plasma torch reactor, the first waveguide configured to direct microwave energy to the first plasma torch reactor.

4. The system of claim 3 further comprising a second waveguide coupled to and in communication with the second plasma torch reactor, the second waveguide configured to direct microwave energy to the second plasma torch reactor.

5. The system of claim 4 further comprising a microwave generator coupled to the first waveguide and the second waveguide, and configured to deliver microwave energy to each of the first waveguide and the second waveguide.

6. The system of claim 3 further comprising:
a first microwave generator coupled to the first waveguide and configured to deliver microwave energy the first waveguide; and
a second microwave generator coupled to the second waveguide and configured to deliver microwave energy to the second waveguide.

7. The system of claim 5, wherein and at least a portion of the waveguide is offset from a microwave inlet of the plasma torch reactor.

8. The system of claim 1, wherein:
the first plasma torch reactor and the second plasma torch reactor are distributed along a length of the header and coupled to the header upstream of the outlet and configured to generate reactive nitrogen species within the collective internal volume, and
the header is further configured to permit oxidation of reactive nitrogen species produced by the first plasma torch reactor and the second plasma torch reactor such that the product fluid stream is generated from reactive nitrogen species produced by the plasma torch reactors.

9. The system of claim 1, wherein the first plasma torch reactor is on an opposing side of the header from the second plasma torch reactor.

10. The system of claim 2, further comprising a third plasma torch reactor and a fourth plasma torch reactor, with the plasma torch reactors longitudinally spaced and arranged orthogonally about the header.

11. The system of claim 1, wherein the header is cylindrical.

12. The system of claim 1, wherein:
the header extends along a longitudinal axis and includes a first side and a second side;
the first plasma torch reactor is disposed on the first side; and
the second plasma torch reactor is disposed on the second side longitudinally offset from the first plasma torch reactor.

13. The system of claim 1, wherein the first plasma torch reactor is coupled to the header by a flanged connection for holding a pressure within the internal volume.

14. The system of claim 1, wherein the header further comprises at least one an inlet in communication with the internal volume, wherein the at least one inlet is configured to deliver at least one of a cooling gas into the internal volume, an oxidizing gas into the internal volume, a liquid into the internal volume, or a solid into the internal volume.

15. The system of claim 1 further comprising a cooling jacket extending about at least a portion of the header.

16. The system of claim 1 further comprising a cooling conduit disposed within the internal volume.

17. The system of claim 1 further comprising ports on the header or plasma torch reactors for equipping the system with temperature, pressure, viewing, or performance measurement devices.

18. The system of claim 1 further comprising an absorption unit in fluid communication with the outlet, the absorption unit configured to receive the product fluid stream and to produce fixed nitrogen compounds from the product fluid stream.

19. The system of claim 1, wherein the header defines a longitudinal axis and the plasma torch reactor includes a plasma reactor outlet oriented perpendicular to the longitudinal axis.

20. The system of claim 1, wherein the first plasma torch reactor is operably coupled to the header to form a turbulent flow of input gases within the header.

21. The system of claim 1, wherein the first plasma reactor and the second plasma reactor are operably coupled with the header to facilitate formation of a vortex flow within the header.

22. The system of claim 1, wherein the first plasma reactor and the second plasma reactor each include outlets into the header oriented to produce a flow toward a center of the header and toward the outlet of the header to facilitate formation of a flow approaching smooth laminar flow.

23. A method comprising:
receiving reactive nitrogen species within an internal volume of a header, the reactive nitrogen species at least partially produced by a plurality of plasma torch reactors coupled to the header and configured to receive streams of nitrogen and oxygen gas and to generate reactive nitrogen species within the internal volume,
producing a product fluid stream including oxidized nitrogen gas species by oxidizing the reactive nitrogen species within the header; and
transporting the product fluid stream to an outlet of the header.

24. The method of claim 23 further comprising producing reactive nitrogen species using the plurality of plasma torch reactors.

25. The method of claim 23, wherein the header receives reactive nitrogen species within the internal volume originating from the plurality of plasma torch reactors coupled to the header.

26. The method of claim 23, wherein the plurality of plasma torch reactors are distributed longitudinally along the header, the header has a cross-section defining a perimeter, and longitudinally neighboring plasma torch reactors are disposed at different locations about the perimeter.

27. The method of claim 23 further comprising delivering a supplemental fluid stream into the internal volume wherein the supplemental fluid stream includes at least one of an oxidizing gas for enhancing oxidation of the reactive nitrogen species within the header, a liquid, a solid or a cooling fluid.

28. The method of claim 23, wherein the product fluid stream is turbulent within the header.

29. The method of claim 23 further comprising forming a vortex in the product fluid stream as the product fluid stream is transported through the header.

30. The method of claim 23 further comprising forming a flow approaching smooth laminar flow as the product fluid stream is propagated through the header.
